(19) United States
(12) Patent Application Publication
(10) Pub. No.: US 2025/0351248 A1
(43) Pub. Date: Nov. 13, 2025

(54) INFORMATION PROCESSING METHOD, INFORMATION PROCESSING DEVICE, AND TASK DETERMINATION METHOD

(71) Applicant: Panasonic Intellectual Property Management Co., Ltd., Osaka (JP)

(72) Inventor: YUKIHIRO MORITA, Osaka (JP)

(21) Appl. No.: 19/277,470

(22) Filed: Jul. 23, 2025

Related U.S. Application Data
(63) Continuation of application No. PCT/JP2024/002311, filed on Jan. 26, 2024.

(30) Foreign Application Priority Data
Feb. 14, 2023 (JP) 2023-021204

(51) Int. Cl. H05B 47/105

(52) U.S. Cl. CPC H05B 47/105

(57) ABSTRACT

An information processing device executes processing for acquiring schedule data that includes information about at least one planned action of a user and processing for controlling an illumination environment of a space where the user is to perform a task according to whether the planned action of the user as indicated by the information included in the schedule data includes a task involving convergent thinking or a task involving divergent thinking.

### BACKGROUND

### 1. Technical Field

The present disclosure relates to a technology for controlling the environment around a user.

### 2. Description of the Related Art

Japanese Unexamined Patent Application Publication No. 2018-56014 discloses an environment control system that switches between concentration scene control, which allows a user to concentrate on intellectual work, and rest scene control, which allows the user to relax from concentration, on the basis of schedule information indicating when to switch between the concentration scene control and the rest scene control. It is disclosed that when the rest scene control is carried out in this environment control system, the color temperature of illuminating light is lowered in comparison to when the concentration scene control is carried out.

### SUMMARY

Intellectual work by a user includes not only tasks involving convergent thinking, such as finding a solution to a problem, but also tasks involving divergent thinking, such as coming up with a new idea. Consequently, when carrying out environment control suited to intellectual work, simply considering a concentration scene as in Japanese Unexamined Patent Application Publication No. 2018-56014 may be inadequate. Furthermore, to carry out environment control suited to intellectual work, it may be necessary to ascertain whether the user is engaged in a task involving convergent thinking or a task involving divergent thinking.

One non-limiting and exemplary embodiment provides a technology for ascertaining the content of intellectual work by a user.

In one general aspect, the techniques disclosed here feature an information processing method to be executed by a computer. The information processing method includes acquiring schedule data that includes information about at least one planned action of a user and controlling an illumination environment of a space where the user is to perform a task according to whether the planned action of the user as indicated by the information included in the schedule data includes a task involving convergent thinking or a task involving divergent thinking.

It should be noted that general or specific embodiments may be implemented as a system, a method, an integrated circuit, a computer program, a storage medium, or any selective combination thereof.

According to the present disclosure, the content of intellectual work by a user may be ascertained.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating an example of a configuration of an environment control system according to an embodiment of the present disclosure;

FIG. 2 is a diagram illustrating an example of a room to which is applied an illumination environment controlled by the environment control device illustrated in FIG. 1;

FIG. 3 is a diagram illustrating an example of a data structure of schedule data;

FIG. 4 is a diagram illustrating an example of a data structure of a correspondence information table;

FIG. 5 is a flowchart illustrating an example of a process by an environment control device according to an embodiment of the present disclosure;

FIG. 6 is a diagram illustrating an example of a control map of environment control;

FIG. 7 illustrates a modification of the flowchart illustrated by FIG. 5;

FIG. 8 is a diagram illustrating an example of a vehicle; and

FIG. 9 is a diagram schematically illustrating an example of a view of the front seats 260 as seen from the position of the rear seats 270 illustrated in FIG. 8.

### DETAILED DESCRIPTIONS

### Underlying Knowledge Forming Basis of an Aspect of the Present Disclosure

Recent years have seen advances in research on controlling the environment of a space where a user performs intellectual work. Intellectual work is known to include tasks involving convergent thinking and tasks with divergent thinking. “Convergent thinking” is defined as thinking to arrive at a single answer by repeatedly thinking and/or reasoning logically on the basis of existing information. For example, thinking about a question that has a definite correct answer and/or thinking to combine multiple ideas and reach one or more conclusions corresponds to convergent thinking. Convergent thinking is also referred to as critical thinking.

“Divergent thinking” is defined as thinking to come up with new ideas by letting one's thoughts wander in various directions on the basis of existing information. For example, thinking to generate ideas through brainstorming or the like corresponds to divergent thinking. Divergent thinking is also referred to as creative thinking.

Consequently, to further increase efficiency in intellectual work, environment control details may be changed depending on whether the intellectual work in question involves convergent thinking or divergent thinking.

However, in the related art, environment control details have not been changed according to the content of intellectual work such as convergent thinking and divergent thinking. For example, in Japanese Unexamined Patent Application Publication No. 2018-56014, properties such as the color temperature of illuminating light are simply changed depending on whether the scene is a concentration scene or a rest scene as described above, and no consideration is given to environment control suited to the content of intellectual work, particularly environment control suited to divergent thinking. Therefore, Japanese Unexamined Patent Application Publication No. 2018-56014 has room for further improvement in increasing the efficiency of intellectual work.

Meanwhile, the spread of web conferencing applications, schedule management applications, and the like have made it easy to acquire schedule data that includes information about a user's schedule.

Accordingly, the inventor arrived at the present disclosure by recognizing that schedule data makes it possible to ascertain the content of intellectual work by a user, which in turn makes it possible to achieve appropriate environment control according to the content of the intellectual work.

(1) An information processing method according to an aspect of the present disclosure is an information processing method to be executed by a computer. The information processing method includes acquiring schedule data that includes information about at least one planned action of a user and controlling an illumination environment of a space where the user is to perform a task according to whether the planned action of the user as indicated by the information included in the schedule data includes a task involving convergent thinking or a task involving divergent thinking.

According to this configuration, since schedule data that includes information about a user's schedule is acquired, it is possible to ascertain whether the user is engaged in a task involving convergent thinking or a task involving divergent thinking. Since the illumination environment of the space where the user is to perform a task is controlled according to convergent thinking and divergent thinking, suitable environment control can be achieved according to the content of intellectual work. As a result, the productivity of the user with respect to intellectual work can be improved.

(2) In the information processing method according to (1), the controlling of the illumination environment may also include: determining, based on the schedule data, whether the planned action of the user includes the task involving convergent thinking or the task involving divergent thinking; controlling the illumination environment to switch to a first illumination environment that leads the user into a convergent thinking state in a first period corresponding to a planned action that includes the task involving convergent thinking; and controlling the illumination environment to switch to a second illumination environment that leads the user into a divergent thinking state in a second period corresponding to a planned action that includes the task involving divergent thinking.

According to this configuration, since it is determined on the basis of the schedule data whether a planned action of the user includes a task involving convergent thinking or a task involving divergent thinking, the user burden of inputting task details can be alleviated.

(3) The information processing method according to (1) or (2) may also be configured such that correspondence information is stored in a memory, the correspondence information indicating a correspondence relation between a name of the planned action and the task involving convergent thinking and a correspondence relation between the name of the planned action and the task involving divergent thinking, and in the determining of the task, the correspondence information and a planned action of the user included in the acquired schedule data are compared to determine whether the planned action of the user includes the task involving convergent thinking or the task involving divergent thinking.

According to this configuration, since correspondence information stored in a memory is used, the correspondence information indicating a correspondence relation between the name of a planned action and a task involving convergent thinking and a correspondence relation between the name of a planned action and a task involving divergent thinking, it can be easily determined whether a planned action of the user includes a task involving convergent thinking or a task involving divergent thinking

(4) The information processing method according to (2) may also be configured such that in the determining of the task, a name of the planned action included in the schedule data is inputted into a model that outputs, based on the name of the planned action, a determination result indicating whether the planned action includes the task involving convergent thinking or the task involving divergent thinking, thereby determining whether the planned action of the user includes the task involving convergent thinking or the task involving divergent thinking.

According to this configuration, since a model that outputs, on the basis of the name of a planned action, a determination result regarding whether the planned action includes a task involving convergent thinking or a task involving divergent thinking, it can be easily determined whether the planned action includes a task involving convergent thinking or a task involving divergent thinking.

(5) The information processing method according to any one of (1) to (4) may further include acquiring identification information for identifying the user, and the acquiring of the schedule data may include acquiring, based on the identification information, schedule data associated with the user.

According to this configuration, since the user's schedule data is acquired on the basis of identification information for identifying the user, the user's schedule data can be acquired correctly.

(6) The information processing method according to (4) may also be configured such that the model is created by being trained on a per-user basis using, as labeled training data, a dataset containing information about planned actions included in schedule data and information indicating whether tasks corresponding to the planned actions involve convergent thinking or divergent thinking.

According to this configuration, a model trained on a per-user basis can be used to determine whether a planned action includes a task involving convergent thinking or a task involving divergent thinking, and the task determination accuracy can be increased.

(7) An information processing device according to a different aspect of the present disclosure is an information processing device including a processor that executes a process including: acquiring schedule data that includes information about at least one planned action of a user; and controlling an illumination environment of a space where the user is to perform a task according to whether the planned action of the user as indicated by the information included in the schedule data includes a task involving convergent thinking or a task involving divergent thinking.

According to this configuration, appropriate environment control can be achieved according to the content of intellectual work, which in turn makes it possible to provide an information processing device capable of increasing the productivity of a user with respect to intellectual work.

(8) A task determination method according to a different aspect of the present disclosure is a task determination method to be executed by a computer, the task determination method including: acquiring schedule data that includes information about at least one planned action of a user; inputting a name of the planned action included in the schedule data into a model that outputs, based on the name of the planned action, a determination result indicating whether the planned action includes a task involving convergent thinking or a task involving divergent thinking, thereby determining whether the planned action of the user includes the task involving convergent thinking or the task involving divergent thinking; and outputting a determination result regarding the planned action.

According to this configuration, since the name of a planned action included in acquired schedule data is inputted to determine whether a planned action of the user includes a task involving convergent thinking or a task involving divergent thinking, the content of intellectual work by the user can be ascertained from the schedule data.

The present disclosure can also be achieved as an information processing program that causes a computer to execute each characteristic element included in such an information processing method, or as an information processing system that operates according to the information processing program. In addition, a computer program like the above obviously may be distributed on a non-transitory computer-readable recording medium such as CD-ROM, or over a communication network such as the Internet.

Note that the embodiments described hereinafter all illustrate specific examples of the present disclosure. Features such as numerical values, shapes, structural elements, steps, and the ordering of steps indicated in the following embodiments are merely examples, and are not intended to limit the present disclosure. In addition, among the structural elements in the following embodiments, structural elements that are not described in the independent claim indicating the broadest concept are described as arbitrary or optional structural elements. Furthermore, the individual contents in all of the embodiments may also be combined.

### Embodiments

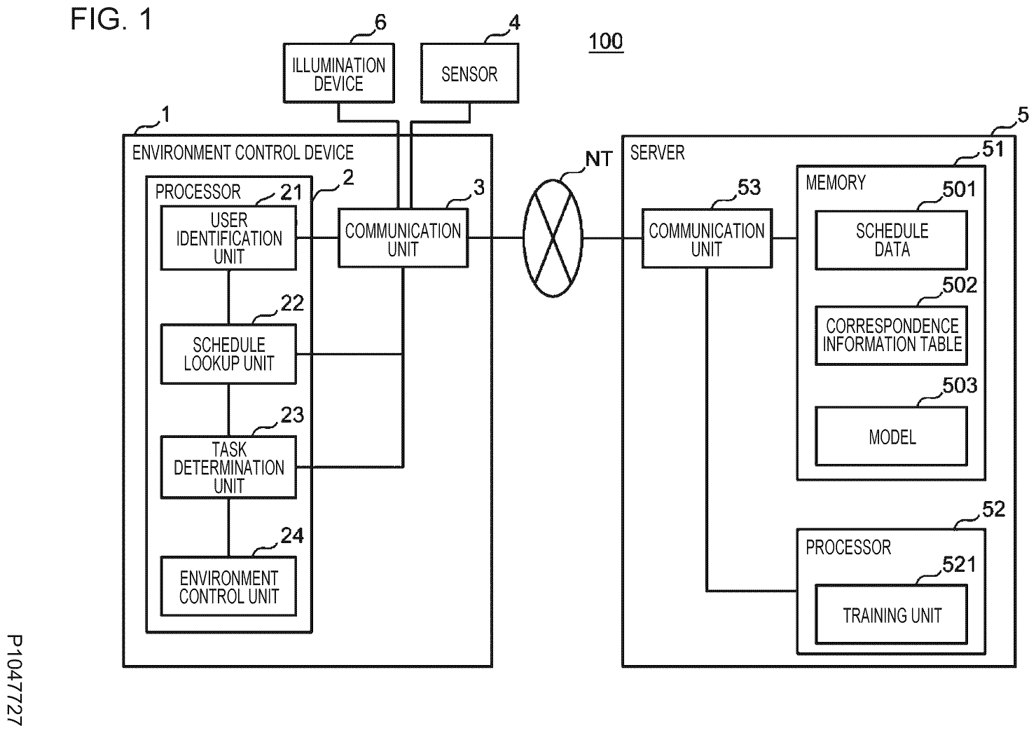

FIG. 1 is a diagram illustrating an example of a configuration of an environment control system 100 according to an embodiment of the present disclosure. The environment control system 100 includes an environment control device 1, a sensor 4, a server 5, and an illumination device 6. The sensor 4, the illumination device 6, and the environment control device 1 are communicatively connected in a wired, wireless, or other way, for example. For example, the sensor 4 and the illumination device 6 are connected via a communication channel such as Wi-Fi®, wireless LAN, or Bluetooth®. The environment control device 1 and the server 5 are communicatively connected via a network NT. One example of the network NT is the Internet. The environment control device 1 is an example of an information processing device.

The environment control device 1, the sensor 4, and the illumination device 6 are installed in a residence of the user or in an office where the user works, for example. However, this is an example, and the environment control device 1 may also be installed in the cloud or built into the server 5.

The environment control device 1 includes a processor 2 and a communication unit 3. The processor 2 is configured using a central processing unit (CPU) or the like, and includes a user identification unit 21, a schedule lookup unit 22, a task determination unit 23, and an environment control unit 24. The user identification unit 21 to the environment control unit 24 are achieved by having the CPU for example execute an information processing program. However, this is an example, and the user identification unit 21 to the environment control unit 24 may also be configured using special-purpose hardware circuitry such as an ASIC. The user identification unit 21 to the environment control unit 24 may be implemented in a single computer, but may also be implemented in a distributed manner in multiple computers.

The user identification unit 21 identifies a user who is to perform a task, and acquires a user ID (identifier) of the identified user. For example, the user identification unit 21 may identify the user by acquiring ID card information acquired from a card reader that reads an ID card carried by the user. In this case, the sensor 4 is configured using an ID card reader. Furthermore, in this case, the user identification unit 21 may acquire a user ID included in the ID card information as the user ID of the user to be identified.

Alternatively, the user identification unit 21 may identify the user by acquiring a face image of the user and applying face authentication processing to the acquired face image. In this case, the sensor 4 is configured using a camera. Furthermore, in this case, the user identification unit 21 may acquire a user ID obtained as a processing result of the face authentication processing as the user ID of the user to be identified.

Alternatively, the user identification unit 21 may identify the user by performing biometric authentication processing such as iris authentication, fingerprint authentication, or vein authentication. In this case, the sensor 4 is configured using an iris sensor, a fingerprint sensor, and/or a sensor that reads vein patterns. Furthermore, in this case, the user identification unit 21 may acquire a user ID obtained as a processing result of the biometric authentication processing as the user ID of the user to be identified.

Alternatively, the user identification unit 21 may acquire user information from the user's personal computer, smartphone, or the like connected via a communication channel such as Wi-Fi or Bluetooth, and identify the user from the acquired user information. In this case, the user identification unit 21 may acquire a user ID included in the acquired user information as the user ID of the user to be identified.

The object of identification is not limited to an individual user and may also be a group including multiple users. In this case, schedule data 501 may contain information indicating a planned action for a group including multiple users. In this case, the environment control described later is carried out in accordance with the planned action for the group that is to use the room to which the environment control device 1 is applied.

The schedule lookup unit 22 looks up schedule data 501 corresponding to the user ID of the user identified by the user identification unit 21. In the example in FIG. 1, the schedule data 501 is stored in a memory 51 of the server 5. Therefore, the schedule lookup unit 22 may acquire the schedule data 501 corresponding to the relevant user ID from the server 5. Note that if the schedule data 501 is stored in the user's personal computer, smartphone, or other device, the schedule lookup unit 22 may connect to the device over a network and acquire t the schedule data 501.

The task determination unit 23 determines whether planned actions of the user as indicated by the schedule data 501 acquired by the schedule lookup unit 22 include a task (work) involving convergent thinking or a task (work) involving divergent thinking. The process of this determination method is described later.

The environment control unit 24 controls the illumination environment of the space where the user is to perform a task according to whether the determination result in the task determination unit 23 indicates that a planned action of the user includes a task involving convergent thinking or a task involving divergent thinking.

Specifically, if the task determination unit 23 has determined that a planned action of the user includes a task involving convergent thinking, the environment control unit 24 switches the illumination environment of the user to a first environment that leads the user into a convergent thinking state in a first period corresponding to the planned action that includes the task. Hereinafter, control to switch to the first environment is referred to as “convergent environment control”. That is, the environment control unit 24 switches the illumination environment to the first environment by applying convergent environment control to the illumination device 6. On the other hand, if the task determination unit 23 has determined that a planned action of the user includes a task involving divergent thinking, the environment control unit 24 switches the illumination environment of the user to a second environment that leads the user into a divergent thinking state in a second period corresponding to the planned action that includes the task. Hereinafter, control to switch to the second environment is referred to as “divergent environment control”. That is, the environment control unit 24 switches the illumination environment to the second environment by applying divergent environment control to the illumination device 6.

The convergent thinking state refers to a state in which the user is thinking convergently. The convergent thinking state may include a state in which the user is concentrating. The divergent thinking state refers to a state in which the user is thinking divergently. The divergent thinking state may include a state in which the user is manifesting creativity.

The first period refers to a period from the scheduled start time to the scheduled end time of a planned action determined to include a task involving convergent thinking. The second period refers to a period from the scheduled start time to the scheduled end time of a planned action determined to include a task involving divergent thinking.

The communication unit 3 includes a communication circuit through which the environment control device 1 communicates with the sensor 4 and the illumination device 6, and a communication circuit for connecting the environment control device 1 to the network NT.

As described above, the sensor 4 is configured using a card reader, a camera, an iris sensor, a fingerprint sensor, and/or a sensor that reads vein patterns, and inputs various information into the communication unit 3.

The illumination device 6 receives a control signal of the environment control unit 24 via the communication unit 3, and emits illuminating light in the room where the user is to perform a task.

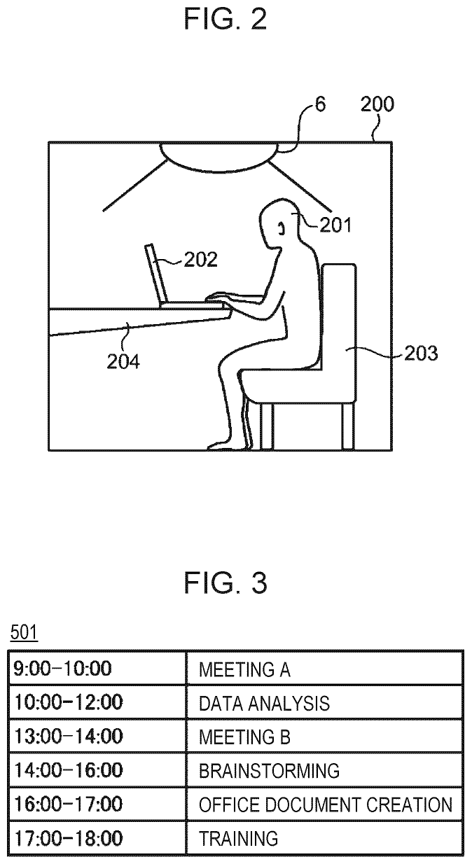

FIG. 2 is a diagram illustrating an example of a room 200 to which is applied an illumination environment controlled by the environment control device 1 illustrated in FIG. 1. The room 200 is a workspace where the user 201 is to perform a task. The room 200 may be a room in the residence of the user 201 or a room in an office where the user 201 is employed. The room 200 is not limited to a workspace where an individual person is to perform a task, and may also be a workspace where multiple persons are to perform a task.

A work medium 202, a chair 203, a desk 204, and the illumination device 6 are installed in the room 200. The user 201 sits in the chair 203 and performs a task using the work medium 202 set up on the desk 204. The work medium 202 is a medium through which the user performs a task, such as a personal computer or a paper document, for example. The illumination device 6 is installed on the ceiling of the room 200. The illumination device 6 may emit illuminating light throughout the room 200 or emit illuminating light in a portion of the room 200 that includes the area around the user 201.

The description will now reference FIG. 1 again. The server 5 includes a memory 51, a processor 52, and a communication unit 53. The memory 51 stores the schedule data 501, a correspondence information table 502, and a model 503. FIG. 3 is a diagram illustrating an example of a data structure of the schedule data 501. The schedule data 501 is created individually for each user ID. The example in FIG. 3 illustrates the schedule data 501 for the user with the user ID “ID_A”.

The schedule data 501 includes information about planned actions of the user. The schedule data 501 is generated on the basis of, for example, information about planned actions entered by the user using a schedule management application installed on a personal computer, a smartphone, or the like.

The schedule data 501 may also include a planned action for rest or the like. In this case, the environment control unit 24 may execute environment control suited to rest. Details will be described later.

In the example in FIG. 3, the schedule data 501 stores information including six planned actions such as “Meeting A” and “Data analysis”. The information including plans includes a time period for each plan and a name (label) for each plan. For example, for the planned action on the first row, the time period of the planned action is from 9:00 to 10:00 and the name of the planned action is “Meeting A”.

In the example in FIG. 3, the schedule data 501 is stored in the server 5, but this is an example. The schedule data 501 may also be stored in a memory (not illustrated) of the environment control device 1, and may also be stored in a personal computer, a smartphone, or the like.

The following three methods may be adopted as the method of determination by the task determination unit 23.

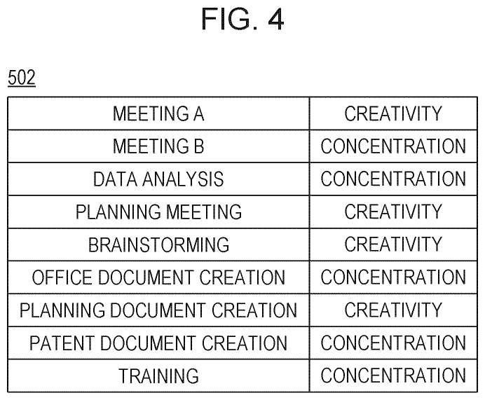

A first example of the determination method is to look up the correspondence information table 502. FIG. 4 is a diagram illustrating an example of a data structure of the correspondence information table 502. In the correspondence information table 502, the names of planned actions included in the schedule data 501 are stored in association with task type information indicating whether the planned action includes a task involving convergent thinking or a task involving divergent thinking.

The convergent thinking state includes a state in which the user is concentrating, while the divergent thinking state includes a state in which the user is manifesting creativity. Therefore, in the example in FIG. 4, “Concentration” is assigned as the task type information for planned actions that include tasks involving convergent thinking, while “Creativity” is assigned as the task type information for planned actions that include tasks involving divergent thinking. Consequently, since the task type information is “Creativity” for the planned action “Meeting A” illustrated in FIG. 3, the task determination unit 23 determines that the planned action includes a task involving divergent thinking. Since the task type information is “Concentration” for the planned action “Data analysis” illustrated in FIG. 3, the task determination unit 23 determines that the planned action includes a task involving convergent thinking.

Note that the correspondence information table 502 may also be stored in a memory (not illustrated) of the environment control device 1 rather than the server 5.

A second example of the determination method is to use schedule data 501 with which task type information is associated. In this case, task type information (not illustrated) is additionally stored in the schedule data 501 illustrated in FIG. 3. The task type information stored in the schedule data 501 is entered by the user. For example, when entering the planned action “Data analysis” indicated on the second row in FIG. 3, if the user judges this planned action to be a task involving convergent thinking, “Concentration” indicating convergent thinking is entered as the task type information for the planned action. In this case, the schedule data 501 further associates and stores “Concentration” as the task type information in addition to the time period of the planned action and the name of the planned action. Consequently, in this case, the task determination unit 23 may determine whether a planned action includes a task involving convergent thinking or a task involving divergent thinking on the basis of the task type information stored in the schedule data 501, without looking up the correspondence information table 502.

A third example of the determination method is to use a model 503. The model 503 is a machine learning model that accepts the name of a planned action as input and outputs a determination result as to whether the planned action includes a task involving convergent thinking or a task involving divergent thinking.

The model 503 is created by being trained on a per-user basis using, as labeled training data, a dataset containing the names of planned actions included in schedule data and information indicating whether tasks corresponding to the planned actions involve convergent thinking or divergent thinking. The machine learning is performed by a training unit 521.

The machine learning is performed once a certain amount of schedule data 501 with associated task type information in the second example has been accumulated. The training unit 521 may generate the model 503 by performing machine learning separately for each user using, as labeled training data, a dataset containing the names of planned actions included in the accumulated schedule data 501 and the task type information for the planned actions. Note that the labeled training data may include rest as a planned action.

Additionally, the training unit 521 may present a determination result from the model 503 to the user and retrain the model 503 on the basis of a user-provided confirmation result indicating whether the determination result is correct or not. For example, the training unit 521 presents, to the user, a list in which the names of planned actions and determination results from the model 503 are associated. The user points out planned actions on the list for which the determination result from the model 503 is incorrect. The training unit 521 revises the determinations results from the model 503 for the planned actions pointed out as incorrect, and causes the model 503 to undergo machine learning again to learn the planned actions with the revised determination results.

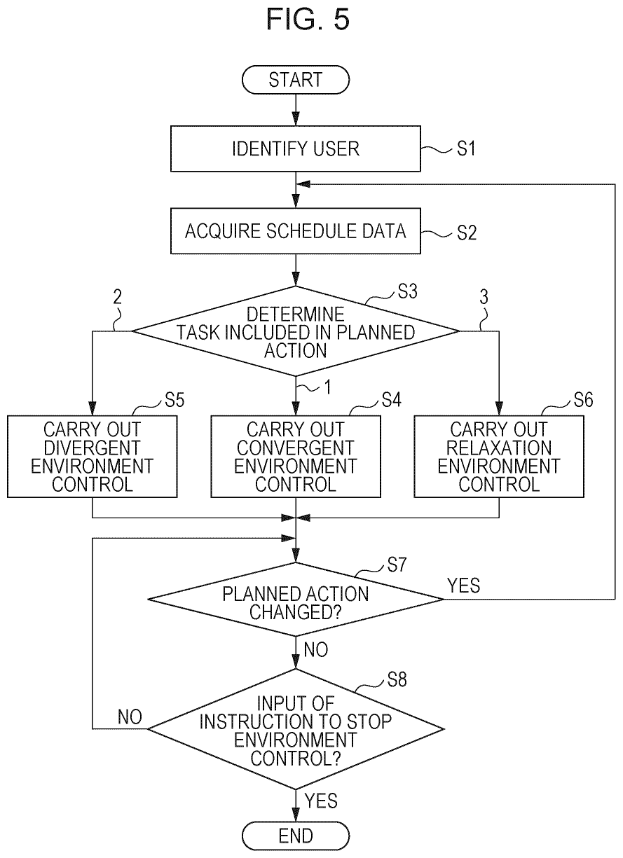

FIG. 5 is a flowchart illustrating an example of a process by the environment control device 1 according to an embodiment of the present disclosure.

First, in step S1, the user identification unit 21 uses any of the methods described above to identify the user present in the room 200 and acquire the user ID of the identified user.

Next, in step S2, the schedule lookup unit 22 acquires the schedule data 501 corresponding to the user ID acquired in step S1. Specifically, the schedule lookup unit 22 inputs an acquisition request, including the user ID acquired in step S1, into the communication unit 3. The communication unit 3 transmits the inputted acquisition request to the server 5 via the network NT. The communication unit 53 of the server 5 receives the acquisition request. The processor 52 of the server 5 acquires, from the memory 51, the schedule data 501 associated with the user ID included in the acquisition request, and inputs the acquired schedule data 501 into the communication unit 53. The communication unit 53 transmits the inputted schedule data 501 to the environment control device 1 via the network NT. The communication unit 3 receives the schedule data 501 transmitted from the server 5 and inputs the received schedule data 501 into the processor 2. This causes the user identification unit 21 to acquire the schedule data 501.

Next, in step S3, the task determination unit 23 determines whether a planned action of the user as indicated by the schedule data 501 acquired in step S2 includes a task involving a convergent thinking, includes a task involving divergent thinking, or is rest. The planned action to be determined at this point is a planned action of the user that is currently scheduled. For example, the planned action to be determined is the planned action whose start time is closest to the current time from among the planned actions included in the schedule data 501.

For example, if the first example of the determination method is adopted, the task determination unit 23 acquires the correspondence information table 502 from the server 5 and looks up the acquired correspondence information table 502 to determine whether the planned action to be determined includes a task involving convergent thinking or a task involving divergent thinking. If the schedule data 501 indicates rest as the name of the planned action to be determined, the task determination unit 23 may determine that the planned action is rest.

Note that the task determination unit 23 may acquire the correspondence information table 502 from the server 5 as follows. First, the task determination unit 23 inputs an acquisition request for the correspondence information table 502 into the communication unit 3. The communication unit 3 transmits the inputted acquisition request to the server 5 via the network NT. The communication unit 53 of the server 5 receives the acquisition request. The processor 52 of the server 5 acquires the correspondence information table 502 from the memory 51 and inputs the acquired correspondence information table 502 into the communication unit 53. The communication unit 53 transmits the inputted correspondence information table 502 to the environment control device 1 via the network NT. The communication unit 3 receives the correspondence information table 502 transmitted from the server 5 and inputs the received correspondence information table 502 into the processor 2. This causes the task determination unit 23 to acquire the correspondence information table 502.

For example, if the second example of the determination method is adopted, the task determination unit 23 looks up the schedule data 501 with which task type information is associated, and on the basis of the content of the task type information associated with the planned action to be determined, determines whether the planned action to be determined includes a task involving convergent thinking, includes a task involving divergent thinking, or is rest.

For example, if the third example of the determination method is adopted, the task determination unit 23 inputs the name of the planned action to be determined into the model 503 stored in the memory 51 of the server 5, acquires from the server 5 a determination result outputted from the model 503, and thereby determines whether the planned action to be determined includes a task involving convergent thinking, includes a task involving divergent thinking, or is rest.

Specifically, the task determination unit 23 inputs a determination request, including the name of the planned action and the user ID, into the communication unit 3. The communication unit 3 transmits the inputted determination request to the server 5 via the network NT. The communication unit 53 of the server 5 receives the determination request. The processor 52 of the server 5 inputs the name of the planned action included in the determination request into the model 503 associated with the user ID included in the determination request. The processor 52 inputs a determination result outputted from the model 503 into the communication unit 53. The communication unit 53 transmits the inputted determination result to the environment control device 1 via the network NT. The communication unit 3 receives the determination result transmitted from the server 5 and inputs the received determination result into the processor 2. This causes the task determination unit 23 to acquire the determination result from the model 503.

In step S3, if it is determined that the planned action of the user includes a task involving convergent thinking (“1” in step S3), the environment control unit 24 executes convergent environment control by transmitting a control signal for executing convergent environment control to the illumination device 6 (step S4).

In step S3, if it is determined that the planned action of the user includes a task involving divergent thinking (“2” in step S3), the environment control unit 24 executes divergent environment control by transmitting a control signal for executing divergent environment control to the illumination device 6 (step S5).

In step S3, if it is determined that the planned action of the user is rest (“3” in step S3), the environment control unit 24 executes relaxation control by transmitting a control signal for executing relaxation control to the illumination device 6 (step S6). Relaxation control refers to control for creating an illumination environment that allows the user to relax.

Next, in step S7, the task determination unit 23 determines whether the planned action has changed. At this point, the task determination unit 23 may look up the schedule data 501 and determine that the planned action has changed if the current time has reached the end time of the planned action to which the environment control is applied. If it is determined that the planned action has changed (YES in step S7), the process returns to step S2. In this case, the process from step S2 is executed again, and environment control suited to the next planned action is executed. On the other hand, if it is determined that the planned action has not changed (NO in step S7), the environment control unit 24 determines whether the user has inputted an instruction for stopping environment control (step S8). The instruction is inputted by the user using a device such as a personal computer or a smartphone, for example. The device transmits an instruction signal indicating the inputted instruction to the environment control device 1. The communication unit 3 receives the instruction signal and inputs the instruction signal into the processor 2. This causes the environment control unit 24 to recognize that the user has inputted an instruction for stopping environment control.

If an instruction for stopping environment control has been inputted (YES in step S8), the process ends. On the other hand, if an instruction for stopping environment control has not been inputted (NO in step S8), the process returns to step S7. In other words, the environment control that was executed in step S4, step S5, or step S6 is continued by the loop of NO in step S7→NO in step S8→step S7.

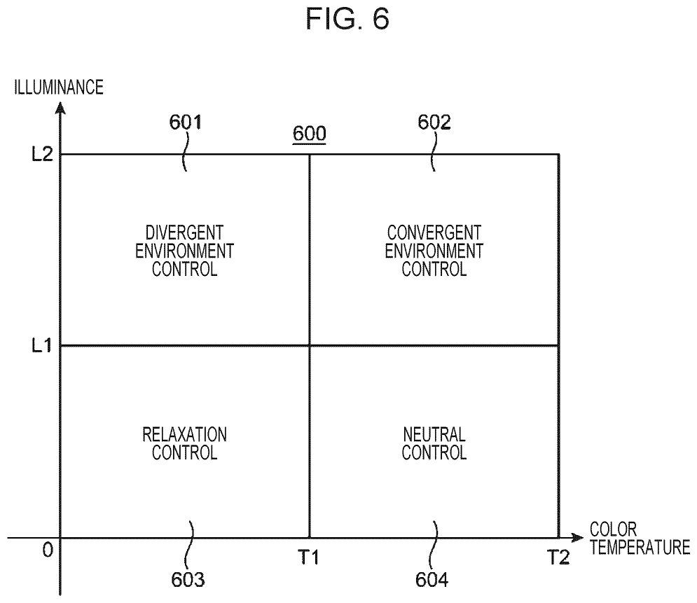

Next, the method of environment control will be described specifically. FIG. 6 is a diagram illustrating an example of a control map 600 of environment control. In the control map 600, the vertical axis represents illuminance and the horizontal axis represents color temperature. The control map 600 includes a region 601 of divergent environment control, a region 602 of convergent environment control, a region 603 of relaxation control, and a region 604 of neutral control. In the region 601 of divergent environment control, the illuminance is greater than a reference illuminance L1 and less than or equal to a reference illuminance L2 (L1<L2), and the color temperature is greater than 0 and less than or equal to a reference color temperature T1. In the region 602 of convergent environment control, the illuminance is greater than the reference illuminance L1 and less than or equal to the reference illuminance L2, and the color temperature is greater than the reference color temperature T1 and less than or equal to a reference color temperature T2 (T1<T2). In the region 603 of relaxation control, the illuminance is greater than 0 and less than or equal to the reference illuminance L1, and the color temperature is greater than 0 and less than or equal to the reference color temperature T1. In the region 604 of neutral control, the illuminance is greater than 0 and less than or equal to the reference illuminance L1, and the color temperature is greater than the reference color temperature T1 and less than or equal to the reference color temperature T2. Note that predetermined values obtained empirically are adopted for the reference color temperatures T1, T2 and the reference illuminances L1, L2.

Fumoto et al. indicate that illumination with high illuminance and low color temperature is used as conditions suitable for work such as brainstorming, that is, conditions suitable for tasks involving divergent thinking (see FUMOTO, Jiichiro et al. “Office lighting system to encourage creativity of workers: Study on optimal lighting conditions for creative work in the office”. Proceedings of Kansai Branch Conference of the Japan Ergonomics Society Kansai Branch, vol. 2009, pp. 171-174, issued on Dec. 5, 2009). Therefore, divergent environment control is executed when the user is performing a task involving divergent thinking. In this case, the environment control unit 24 determines an optional or predetermined illuminance and an optional or predetermined color temperature from within the region 601 of divergent environment control, generates a control signal including the determined illuminance and color temperature, and inputs the generated control into the illumination device 6.

Fumoto et al. indicate that illumination with high illuminance and high color temperature is used as conditions suitable for tasks involving convergent thinking. Therefore, convergent environment control is executed when the user is performing a task involving convergent thinking. In this case, the environment control unit 24 determines an optional or predetermined illuminance and an optional or predetermined color temperature from within the region 602 of convergent environment control, generates a control signal including the determined illuminance and color temperature, and inputs the generated control into the illumination device 6.

Fumoto et al. indicate that illumination with low illuminance and low color temperature is used as conditions suitable for a comfortable state. Therefore, relaxation control is executed in a period during which the user rests. In this case, the environment control unit 24 determines an optional or predetermined illuminance and an optional or predetermined color temperature from within the region 603 of relaxation control, generates a control signal including the determined illuminance and color temperature, and inputs the generated control into the illumination device 6.

It is anticipated that in some cases, a planned action of the user does not correspond to any of including a task involving convergent thinking, including a task involving divergent thinking, or being rest. In this case, the environment control unit 24 may execute neutral control. The environment control unit 24 determines an optional or predetermined illuminance and an optional or predetermined color temperature from within the region 604 of neutral control, generates a control signal including the determined illuminance and color temperature, and inputs the generated control into the illumination device 6.

As described above, according to the present embodiment, since the schedule data 501 that includes information about a user's schedule is acquired, it is possible to ascertain whether the user is engaged in a task involving convergent thinking or a task involving divergent thinking. Since the illumination environment of the space where the user is to perform a task is controlled according to convergent thinking and divergent thinking, suitable environment control can be achieved according to the content of intellectual work. As a result, the productivity of the user with respect to intellectual work can be improved.

Note that the present disclosure may implement the following modifications.

(1) In the case where the second example of the determination method described above is adopted, the task determination unit 23 may be omitted. In this case, the environment control unit 24 may execute convergent environment control if the task type information corresponding to the planned action is “Concentration” and execute divergent environment control if the task type information corresponding to the planned action is “Creativity”.

(2) The four regions 601 to 604 illustrated in FIG. 6 may touch each other or be apart from each other.

(3) In FIG. 1, the schedule data 501, the correspondence information table 502, the model 503, and the training unit 521 are provided in the server 5, but any one or more of the above may also be provided in the environment control device 1.

(4) The user identification unit 21 may identify the user according to information from a beacon device provided in the room 200. The user carries a beacon unit. The beacon unit may be built into a smartphone, or may be built into a card such as an ID. Upon receiving a beacon signal from the beacon device, the beacon unit transmits user information, including the user ID of the user, to the beacon device. The beacon device, having received the user information, transmits the user information to the environment control device 1, and the communication unit 3 receives the user information.

Consequently, if the communication unit 3 has received user information transmitted from the beacon device, the user identification unit 21 may determine that the user is present in the room 200. Although the above describes the beacon device as transmitting the beacon signal, the beacon unit may also transmit the beacon signal that includes the user information. In this case, the beacon device, having received the beacon signal from the beacon unit, may transmit the user information included in the beacon signal to the environment control device 1.

(5) In the environment control device 1 illustrated in FIG. 1, the schedule lookup unit 22 and the task determination unit 23 may form a task determination device that executes a task determination method. In this case, the schedule lookup unit 22 acquires the schedule data 501, including information about at least one planned action of the user. The task determination unit 23 inputs the name of a planned action included in the schedule data 501 into the model 503 to determine whether the planned action of the user includes a task involving convergent thinking or a task involving divergent thinking, and outputs a determination result. The determination result may be outputted outside the environment control device 1, or may be outputted to the memory of the environment control device 1.

(6) The environment control system 100 may also be provided with a display device 7. The environment control system 100 may also control the display device 7 disposed in the space where the user is to perform a task according to whether the determination result in the task determination unit 23 indicates that a planned action of the user includes a task involving convergent thinking or a task involving divergent thinking. Like the illumination device 6, the display device 7 is communicatively connected to the communication unit 3 in a wired, wireless, or other way. The display device 7 may also be a device including a screen and a projector that projects light onto the screen. The display device 7 may also be a display with pixels that displays an image by emitting light from each of the pixels.

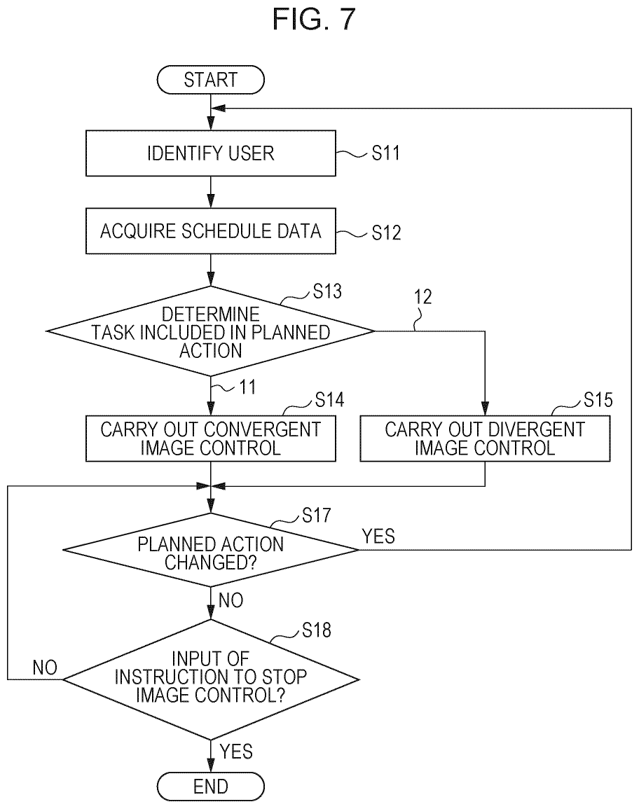

FIG. 7 illustrates a modification of the flowchart illustrated by FIG. 5. Note that steps S11 to S13, step S17, and step S18 of FIG. 7 are the same operations as steps S1 to S3, step S7, and step S8 of FIG. 5, respectively, and therefore a description is omitted.

In S14, the environment control unit 24 executes convergent image control by transmitting a control signal for executing convergent image control to the display device 7.

Convergent image control may be control causing the display device 7 to display an image for leading the user into a convergent thinking state. The convergent image may be a still image or a video image containing multiple images.

The convergent image may be an image illustrating a closed space, for example. The image illustrating a closed space may be an image illustrating a space with a low ceiling, and may also be an image illustrating a space of shallow depth. The convergent image may also be an image in which a grid pattern composed of straight lines is drawn.

In S15, the environment control unit 24 executes divergent image control by transmitting a control signal for executing divergent image control to the display device 7.

Divergent image control may be control causing the display device 7 to display an image for leading the user into a divergent thinking state. The divergent image may be a still image or a video image containing multiple images.

The divergent image may be an image illustrating an open space, for example. The image illustrating an open space may be an image illustrating a space with a high ceiling, and may also be an image illustrating a space of deep depth. The divergent image may also be an image in which a pattern composed of curved lines is drawn.

The convergent image and the divergent image may be stored in the memory 51.

The relationships between convergent thinking and divergent thinking and between closed and open spaces are described in, for example, Joan Meyers-Levy and Rui Zhu, “The Influence of Ceiling Height: The Effect of Priming on the Type of Processing That People Use” (2007).

The relationships between convergent thinking and divergent thinking and between curved lines and straight lines are described in, for example, Moshe Bar and Maital Neta, “Visual elements of subjective preference modulate amygdala activation” (2006). The operations indicated in S13, S14, and S15 may cause the image displayed by the display device 7 to be switched appropriately according to the content of intellectual work to be performed by the user, and thus may improve the user's productivity.

(7) The environment control system 100 may be provided with a speaker 8 that outputs sound. The environment control system 100 may also control the speaker 8 disposed in the space where the user is to perform a task according to whether the determination result in the task determination unit 23 indicates that a planned action of the user includes a task involving convergent thinking or a task involving divergent thinking. Like the illumination device 6, the speaker 8 is communicatively connected to the communication unit 3 by speaker wire or the like.

In step S5 of the flowchart illustrated in FIG. 5, the environment control unit 24 may cause the speaker 8 to output music that elicits a divergent thinking state. The music that elicits a divergent thinking state may be, for example, music that imparts a feeling of happiness.

In step S4 of the flowchart, the environment control unit 24 may execute control causing the speaker 8 to stop outputting music or to maintain a state of not outputting music.

Findings regarding music that elicits a divergent thinking state are disclosed in, for example, Carolyn Crist, “Happy music linked to creative thinking” (2017).

Music that elicits a divergent thinking state may be stored in the memory 51.

Thus, as indicated in (6) and (7), the environment control system 100 may also carry out control to impart a stimulus related to the five senses such as vision and hearing.

(8) The room 200 may also be a space inside a moving body. The moving body may be stopped or moving in the period during which the user performs work. For example, the moving body may be a vehicle.

The environment control device 1 is installed in the vehicle. However, this is an example, and the environment control device 1 may also be installed in the cloud or built into the server 5.

The processor 2 may be an electronic control unit (ECU) that comes standard with the vehicle, or may be configured separately from an ECU.

The illumination device 6 may be an illumination device that comes standard with the vehicle, or may be provided separately from an illumination device that comes standard with the vehicle.

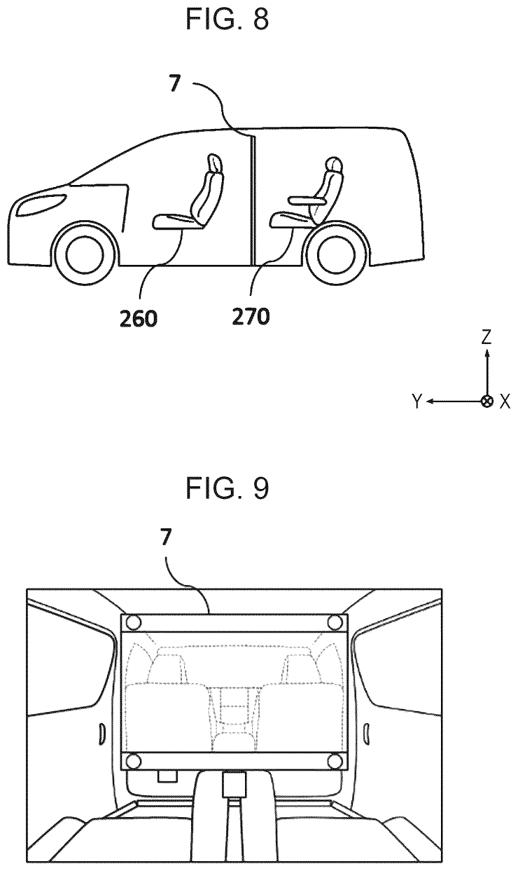

FIG. 8 is a diagram illustrating an example of a vehicle. As described in (6), the environment control system 100 may also be provided with the display device 7, and the display device 7 may be disposed between front seats 260 of the vehicle and rear seats 270 of the vehicle, as illustrated in FIG. 8. The front seats 260 include a driver's seat and a passenger seat.

FIG. 9 is a diagram schematically illustrating an example of a view of the front seats 260 as seen from the position of the rear seats 270 illustrated in FIG. 8. The display device may include a dimming sheet with a controllable transmittance. The display device may be configured such that the transmittance can be controlled to allow a user to see in the forward direction of the vehicle from the rear seats 270 through the display device 7.

The display device may have a back surface and a display surface on which an image is to be displayed. The display surface may be located on the side of the rear seats 270 and the back surface may be located on the side of the front seats 260. In other words, the display device 7 may be disposed to present an image to a user in the rear seats 270 who is to perform work and/or participate in a meeting using a computer or the like.

Modifications of embodiments of the present disclosure may also be like the following.

### Appendix 1

An information processing method to be executed by a computer, the information processing method including: acquiring schedule data that includes information about at least one planned action of a user; and controlling equipment, which is disposed in a space where the user is to perform a task and which imparts a stimulus related to one or more of the five senses, according to whether the planned action of the user as indicated by the information included in the schedule data includes a task involving convergent thinking or a task involving divergent thinking.

### Appendix 2

The equipment is a display device that displays an image.

### Appendix 3

The display device is disposed between a front seat and a rear seat of a vehicle, and a display surface of the display device is located on the rear-seat side.

### Appendix 4

The equipment is a speaker that outputs sound.

The present disclosure may improve the productivity of a user with respect to intellectual work, and thus is useful in the technical field of creating a work environment for a user.

What is claimed is:

1. An information processing method to be executed by a computer, the information processing method comprising:
acquiring schedule data that includes information about at least one planned action of a user; and
controlling an illumination environment of a space where the user is to perform a task according to whether the planned action of the user as indicated by the information included in the schedule data includes a task involving convergent thinking or a task involving divergent thinking.

2. The information processing method according to claim 1, wherein
the controlling of the illumination environment includes:
determining, based on the schedule data, whether the planned action of the user includes the task involving convergent thinking or the task involving divergent thinking;
controlling the illumination environment to switch to a first illumination environment that leads the user into a convergent thinking state in a first period corresponding to a planned action that includes the task involving convergent thinking; and
controlling the illumination environment to switch to a second illumination environment that leads the user into a divergent thinking state in a second period corresponding to a planned action that includes the task involving divergent thinking.

3. The information processing method according to claim 2, wherein
correspondence information is stored in a memory, the correspondence information indicating a correspondence relation between a name of the planned action and the task involving convergent thinking and a correspondence relation between the name of the planned action and the task involving divergent thinking, and
in the determining of the task, the correspondence information and a planned action of the user included in the acquired schedule data are compared to determine whether the planned action of the user includes the task involving convergent thinking or the task involving divergent thinking.

4. The information processing method according to claim 2, wherein
in the determining of the task, a name of the planned action included in the schedule data is inputted into a model that outputs, based on the name of the planned action, a determination result indicating whether the planned action includes the task involving convergent thinking or the task involving divergent thinking, thereby determining whether the planned action of the user includes the task involving convergent thinking or the task involving divergent thinking.

5. The information processing method according to claim 1, further comprising:
acquiring identification information for identifying the user, wherein
the acquiring of the schedule data includes acquiring, based on the identification information, schedule data associated with the user.

6. The information processing method according to claim 4, wherein
the model is created by being trained on a per-user basis using, as labeled training data, a dataset containing information about planned actions included in schedule data and information indicating whether tasks corresponding to the planned actions involve convergent thinking or divergent thinking.

7. An information processing device comprising a processor that executes a process comprising:
acquiring schedule data that includes information about at least one planned action of a user; and
controlling an illumination environment of a space where the user is to perform a task according to whether the planned action of the user as indicated by the information included in the schedule data includes a task involving convergent thinking or a task involving divergent thinking.

8. A task determination method to be executed by a computer, the task determination method comprising:
acquiring schedule data that includes information about at least one planned action of a user;
inputting a name of the planned action included in the schedule data into a model that outputs, based on the name of the planned action, a determination result indicating whether the planned action includes a task involving convergent thinking or a task involving divergent thinking, thereby determining whether the planned action of the user includes the task involving convergent thinking or the task involving divergent thinking; and
outputting a determination result regarding the planned action.

9. An information processing method to be executed by a computer, the information processing method comprising:
acquiring schedule data that includes information about at least one planned action of a user; and
controlling equipment, which is disposed in a space where the user is to perform a task and which imparts a stimulus related to one or more of the five senses, according to whether the planned action of the user as indicated by the information included in the schedule data includes a task involving convergent thinking or a task involving divergent thinking.

10. The information processing method according to claim 9, wherein
the equipment is a display device that displays an image.

11. The information processing method according to claim 10, wherein
the display device is disposed between a front seat and a rear seat of a vehicle, and
a display surface of the display device is located on the rear-seat side.

12. The information processing method according to claim 9, wherein
the equipment is a speaker that outputs sound.
